(19) United States
(12) Patent Application Publication
(10) Pub. No.: US 2009/0310243 A1
(43) Pub. Date: Dec. 17, 2009

(54) MAGNETIC HEAD AND MAGNETIC STORAGE DEVICE

(75) Inventor: Kenichiro Aoki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/365,664

(22) Filed: Feb. 4, 2009

(30) Foreign Application Priority Data
Jun. 13, 2008 (JP) 2008-155684

(51) Int. Cl. G11B 5/02

(52) U.S. Cl. 360/59; G9B/5.026

(57) ABSTRACT

A magnetic head that floats up while directing an air bearing surface to a relatively moving storage medium and stores information into the storage medium, the magnetic head includes: a main magnetic pole that generates a magnetic field for recording information into the storage medium; and a heater that adjusts a floating-up amount of the magnetic head from the storage medium by deforming the air bearing surface with heat, wherein the heater has a shape that extends towards the air bearing surface up to a proximate distance at which a distance from the air bearing surface overlaps with the main magnetic pole while monotonously decreasing the distance from the air bearing surface to pass a proximate point to the main magnetic pole, and that extends away from the air bearing surface while monotonously increasing the distance from the air bearing surface after passing the proximate point.

### CROSS-REFERENCE TO RELATED APPLICATION

This application is based upon and claims the benefit of priority of the prior Japanese Patent Application No. 2008-155684, filed on Jun. 13, 2008, the entire contents of which are incorporated herein by reference.

### FIELD

The embodiments discussed herein are related to a magnetic head and a magnetic storage device.

### BACKGROUND

Conventionally, a magnetic storage device is widely used by being incorporated into or externally attached to a computer. In the magnetic storage device, a magnetic head slider having a magnetic head fixed thereto floats up from a surface of the magnetic disk by an airflow caused by the rotation of the magnetic disk, and in this state, the magnetic head accesses the information stored in the magnetic disk.

A floating-up amount of the magnetic head from the magnetic disk surface is reduced year after year in accordance with increasing recording density of the magnetic disk, and at present, the floating-up amount is 10 nm or less. The head floating-up amount is likely to fluctuate, affected by operating environments such as temperature and atmospheric pressure, and variations in the shape of a floating surface (ABS: Air Bearing Surface) of the magnetic head slider.

Hence, there is proposed a method of incorporating a heater in a magnetic head slider having a magnetic head mounted thereon, generating heat by energizing the heater, and adjusting a floating-up amount by thermally deforming the magnetic head (see Japanese Laid-open Patent Publication No. 05-20635 and U.S. Pat. No. 5,991,113, for example). According to this method, a gap between the tip of the magnetic pole and the magnetic disk is reduced. There is also proposed a technique in which a sheet resistance of a pulled-out portion of a heater is reduced smaller than that of a portion of the heater closer to the element, heat generating efficiency of the heater is enhanced, and a member having thermal conductivity higher than that of alumina is disposed around the heater (see Japanese Laid-open Patent Publication Nos. 2004-335069 and 2006-53972, for example). There is also proposed a technique in which two heaters are disposed in layers or a heater is disposed in a magnetic head which employs a helical coil (see Japanese Laid-open Patent Publications Nos. 2007-287277 and 2006-244692, for example). There is also proposed a method in which a heater is incorporated in a magnetic head for heat assisted recording that records by locally heating the magnetic disk (see U.S. Pat. Nos. 6,493,183, 7,023,660, and 7268973, for example).

In the magnetic head that adjusts the floating-up amount by thermal deformation, it is desired to ensure the high reliability and to increase the deformation amount of the air bearing surface further while restraining the increase in the electric current. In the above-described techniques, a meandering heater is disposed in order to increase the amount of heat generation; however, the meandering heater can be disposed only at a position spaced apart from the air bearing surface, leading to decrease in the heat generation efficiency. Also, the magnetic head that employs a helical coil has a complex connection structure in order to energize the main magnetic pole. Also, in the magnetic head for heat assisted recording, no consideration is given to the adjustment of the floating-up amount of the magnetic head.

### SUMMARY

According to an aspect of the invention, a magnetic head that floats up while directing an air bearing surface to a relatively moving storage medium and stores information into the storage medium includes: a main magnetic pole that generates a magnetic field for recording information into the storage medium; and a heater that adjusts a floating-up amount of the magnetic head from the storage medium by deforming the air bearing surface with heat, wherein the heater has a shape that extends towards the air bearing surface up to a proximate distance at which a distance from the air bearing surface overlaps with the main magnetic pole while monotonously decreasing the distance from the air bearing surface to pass a proximate point to the main magnetic pole, and that extends away from the air bearing surface while monotonously increasing the distance from the air bearing surface after passing the proximate point.

Here, the terms “monotonously decreasing” and “monotonously increasing” are used to include the meaning of having a constant distance in a part of regions.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a concrete embodiment of a magnetic storage device;

FIG. 2 is a view illustrating the magnetic head depicted in FIG. 1;

FIG. 3 is an enlarged cross-sectional view illustrating a structure of an element forming section of the magnetic head depicted in FIG. 2;

FIG. 4 is a view illustrating the shape of a heater in the magnetic head of FIG. 3;

FIG. 5 is a view illustrating a magnetic head as a comparative example;

FIG. 6 is a graph depicting the distribution of the protrusion amount at the air bearing surface of the magnetic head for each of plural magnetic heads;

FIG. 7 is a graph depicting the distribution of the protrusion time constant at the air bearing surface of the magnetic head for each of plural magnetic heads;

FIG. 8 is a view illustrating an arrangement condition for a main magnetic pole and an auxiliary magnetic pole in the leakage magnetic flux analysis;

FIG. 9 is a graph illustrating a distribution of the medium perpendicular direction magnetic flux;

FIG. 10 is an enlarged cross-sectional view illustrating a structure of an element forming section of the magnetic head in the second embodiment;

FIG. 11 is an enlarged cross-sectional view illustrating a structure of an element forming section of the magnetic head in the third embodiment;

FIG. 12 is a view for describing a structure of the heater depicted in FIG. 11;

FIG. 13 is an enlarged cross-sectional view illustrating a structure of an element forming section of the magnetic head in the fourth embodiment;

FIG. 14 is a view illustrating a structure of the heater of the magnetic head in the fifth embodiment;

FIG. 15 is a view illustrating a structure of the heater of the magnetic head in the sixth embodiment;

FIG. 16 is a view illustrating a structure of the heater of the magnetic head in the seventh embodiment;

FIG. 17 is a view illustrating a structure of the heater of the magnetic head in the eighth embodiment;

FIGS. 18A and 18B are views illustrating a structure of the heater of the magnetic head in the ninth embodiment;

FIG. 19 is a view illustrating a first modification example in which the position of the heater joint is different; and

FIG. 20 is a view illustrating a second modification example in which the position of the heater joint is different.

### DESCRIPTION OF EMBODIMENTS

Hereafter, concrete embodiments of the invention of the magnetic head and the magnetic storage device disclosed in the present specification will be described.

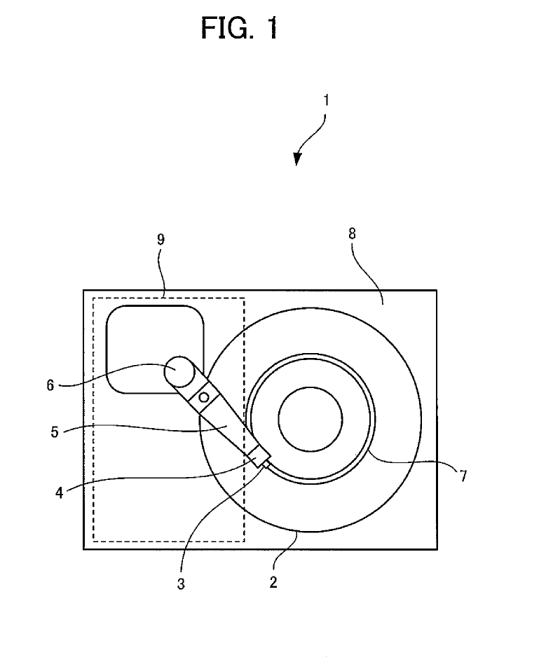

FIG. 1 is a view illustrating a concrete embodiment of a magnetic storage device.

A magnetic storage device 1 depicted in FIG. 1 is provided with a rotary actuator 6 that generates a rotation driving force with its rotation axis being in the direction perpendicular to the Figure. This rotary actuator 6 supports a suspension arm 5. By receiving the rotation driving force of the rotary actuator 6, the suspension arm 5 rotates around the rotary actuator 6 in the plane of the Figure. At the tip end of the suspension arm 5, a magnetic head 3 is attached via a gimbal 4 serving as a supporting tool. The magnetic head 3 reads information from a magnetic disk 2 as a storage medium, and writes information into the magnetic disk 2.

In reading or writing the information, the suspension arm 5 is driven and rotated by the rotary actuator 6, whereby the magnetic head 3 moves to a target position above the magnetic disk 2 so as to read information from a magnetic disk 2 or to write information into the magnetic disk 2. On the surface of the disk-shaped magnetic disk 2, numerous tracks 7 are concentrically provided, and on each track 7, unit storage regions each storing information of one bit, which are called one-bit regions, are arranged along the track 7. These one-bit regions are provided with a magnetization that is directed in the direction perpendicular to the surface of the magnetic disk 2 (in the in-plane direction in the case of the in-plane storage method). Information of one bit is represented by the direction of the magnetization. This magnetic disk 2 rotates in the plane of the Figure by having the center of the disk as a center of rotation, and the magnetic head 3 disposed near the surface of the magnetic disk 2 sequentially comes close to each one-bit region of the rotating magnetic disk 2.

At the time of recording information, an electric recording signal is input into the magnetic head 3 that has come close to the magnetic disk 2, and the magnetic head 3 applies a magnetic field to each one-bit region in accordance with the input recording signal, whereby the information carried in the recording signal is recorded in a form of magnetization direction of each of those one-bit regions. Also, at the time of reproducing the information, the magnetic head 3 collects the information stored in a form of magnetization direction of each of the one-bit regions by generating an electric reproduction signal in accordance with the magnetic field generated from each magnetization. Here, when the magnetic head 3 reads or writes information on a different track 7 after reading information on one track 7, the suspension arm 5 receiving the rotation driving force of the rotary actuator 6 is rotated, whereby the magnetic head 3 moves to the position close to the different track 7, and the magnetic head 3 reads or writes information by the above-described method in each of the one-bit regions of the different track 7.

Each of the sections that are directly involved in the storage and reproduction of information, such as the rotary actuator 6, the suspension arm 5, the gimbal 4, and the magnetic head 3, is housed in a base 8 together with the magnetic disk 2. FIG. 1 depicts the appearance of the inside of the base 8. In the rear of the base 8, there is provided a control substrate 9 in which an electronic circuit for controlling each of the sections is formed. Each of the sections is electrically connected to this control substrate 9 by a mechanism not illustrated in the drawings, whereby the recording signal that is input into the magnetic head 3 or the reproduction signal generated in the magnetic head 3 is processed in this control substrate 9. Also, the control substrate 9 supplies electric current to a heater that is described later, incorporated in the magnetic head 3, so as to control the distance between the magnetic head 3 and the magnetic disk 2.

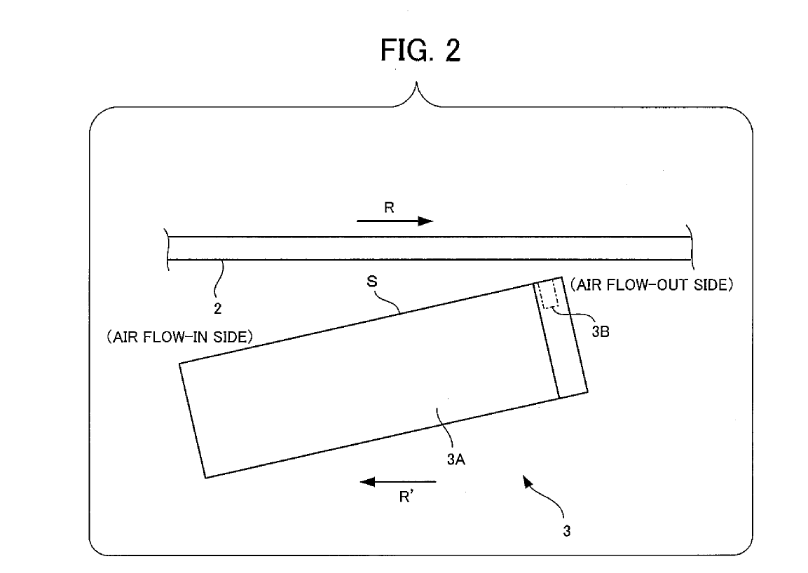

FIG. 2 is a view illustrating the magnetic head depicted in FIG. 1. In FIG. 2, the magnetic head 3 is depicted together with the magnetic disk 2.

The magnetic head 3 is provided with a slider 3A that floats up above the magnetic disk 2 by an air stream generated by rotation of the magnetic disk 2 and an element forming section 3B which is fixed to the air flow-out side of the slider 3A and in which an element that makes access to the magnetic disk 3 is formed. The magnetic disk 3 moves in the direction of the arrow R′ relatively to the magnetic disk 2 that rotates in the direction of the arrow R. To the magnetic head 3, a force is given by the gimbal 4 in a direction that makes contact to the magnetic disk 2 (the upward direction in the FIG. 2). However, by the air stream that flows from the air flow-in side to the air flow-out side in accordance with the rotation of the magnetic disk 2, the magnetic head 3 floats up above the magnetic disk 2 (the downward direction in FIG. 2) in a posture such that the air bearing surface S faces the magnetic disk 2.

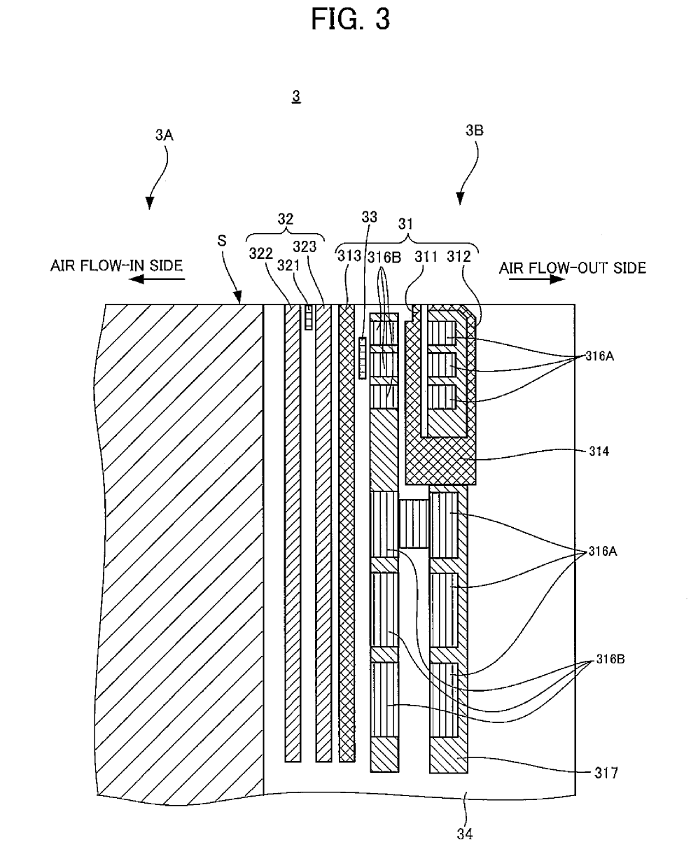

FIG. 3 is an enlarged cross-sectional view illustrating a structure of an element forming section of the magnetic head depicted in FIG. 2.

The element forming section 3B is provided with a recording element 31 that applies a magnetic field to each of the one-bit regions in accordance with the recording signal at the time of recording information so as to record the information in a form of a magnetization direction, a reproduction element 32 that generates an electric reproduction signal representing the information in accordance with the magnetic field that is generated from the respective magnetization of each of the one-bit regions at the time of reproducing the information, and a heater 33. The element forming section 3B has a structure such that the recording element 31, the reproduction element 32, and the heater 33 are sequentially laminated via an insulating layer 34 made of alumina on the slider 3A serving as the supporting substrate. Hereafter, the slider 3A will be also referred to as a supporting substrate 3A.

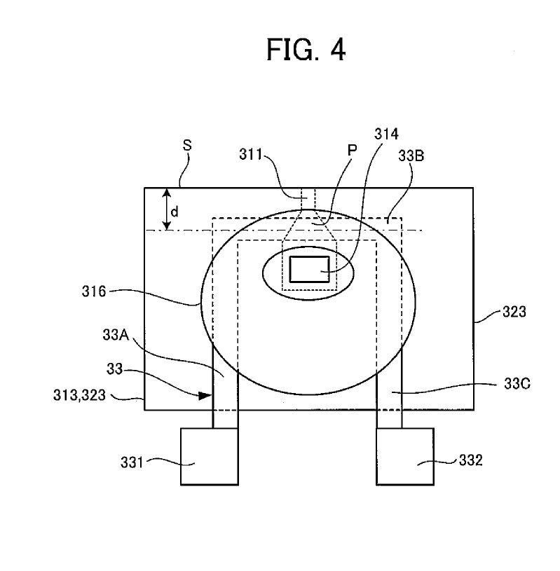

The recording element 31 is provided with a main magnetic pole 311, auxiliary magnetic poles 312, 313 that are disposed to interpose the main magnetic pole 311 therebetween, a connection section 314 that connects the main magnetic pole 311 to the auxiliary magnetic poles 312, 313, and thin film coils 316A, 316B for recording. The main magnetic pole 311, the auxiliary magnetic poles 312, 313, and the connection section 314 are formed of an alloy (Ni—Fe) of nickel (Ni) and iron (Fe). Also, an insulating resin 317 is filled in the surroundings of the thin film coils 316A, 316B. The recording element 31 of the present embodiment uses a double coil system in which the main magnetic pole 311 is sandwiched from both sides to generate a magnetic field. The main magnetic pole 311, a first auxiliary magnetic pole 312 located on the air flow-out side, and the connection section 314 construct a part of the first magnetic path of the magnetic flux generated at the time of magnetic recording. The thin film coil 316A that is located on the air flow-out side is disposed to intersect this first magnetic path. On the other hand, the main magnetic pole 311 and the second auxiliary magnetic pole 313 that is located on the air flow-in side construct a part of the second magnetic path. The thin film coil 316B disposed on the air flow-in side intersects this second magnetic path. The main magnetic pole 311 has a shape of being tapered from the connection section 314 toward the tip end that faces the magnetic disk 2 (See FIG. 4).

The reproduction element 32 is an element that performs reproduction of information by using the gigantic magnetic resistance effect (GMR effect), and is provided with a magnetic resistance effect film 321 and magnetic shield layers 322, 323. The two magnetic shield layers 322, 323 are disposed at positions that interpose the magnetic resistance effect film 321 therebetween. As the magnetic resistance effect film 321, those using the tunnel magnetic resistance effect (TMR effect) instead of the GMR can also be used. The magnetic shield layers 322, 323 are formed of an alloy (Ni—Fe) of nickel (Ni) and iron (Fe), and have a high magnetic permeability.

The heater 33 adjusts the floating-up amount of the magnetic head 3 from the magnetic disk 2 by deforming the air bearing surface S of the magnetic head 3 with heat. In the present embodiment, the heater 33 is disposed nearer to the recording element 31 side than the magnetic shield layer 323 that is disposed on the recording element 31 side, of the two magnetic shield layers 322, 323 of the reproduction element 32. In more detail, the heater 33 is disposed within the recording element 31.

FIG. 4 is a view illustrating a shape of the heater in the magnetic head of FIG. 3. FIG. 4 illustrates the shape of the heater 33 as viewed in the moving direction R′ of the magnetic head.

Referring to FIG. 4, the heater 33 has a shape that extends towards the air bearing surface S up to a proximate distance d at which the distance from the air bearing surface S overlaps with the main magnetic pole 311 while monotonously decreasing the distance from the air bearing surface S to pass the proximate point p to the main magnetic pole 311, and that extends away from the air bearing surface S while monotonously increasing the distance from the air bearing surface S after passing a proximate point p. In more detail, the heater 33 is made of one layer, and made of a pair of approach sections 33A, 33C that linearly extend from the respective two heater joints 331, 332 serving as connection terminals towards the air bearing surface S up to the position at which the distance from the air bearing surface S becomes a proximate distance d, and a parallel section 33B that extends generally in parallel with the air bearing surface S so as to connect the tip ends of the approach sections 33A, 33C with each other. The material of the heater 33 is nickel copper; however, tungsten or titanium tungsten instead of nickel copper can also be used.

The supporting substrate 3A is a substrate (AlTiC substrate) in which an aluminum oxide film is formed on the surface of a non-magnetic material having aluminum oxide (Al₂O₃) and titanium carbide (TiC).

In the magnetic head 3 depicted in FIGS. 3 and 4, when an electric current is supplied from the control substrate 9 (See FIG. 1) to the heater 33, the heater 33 neighboring portion of the magnetic head 3 is heated, whereby the air bearing surface S is deformed so as to protrude towards the magnetic disk 2.

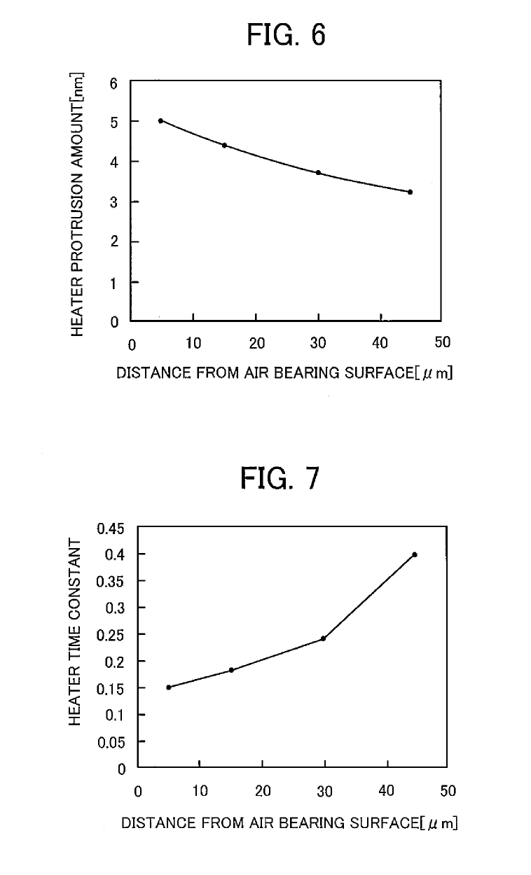

FIGS. 6 and 7 are graphs that illustrate the distribution of deformation on the air bearing surface of plural magnetic heads when a heater is energized with an electric current for the plural magnetic heads having a different distance of the heater from the air bearing surface to one another. FIG. 6 illustrates a protrusion amount (heater protrusion amount) of a magnetic head at the air bearing surface, and FIG. 7 illustrates a time constant representing a protrusion speed. Here, the distance of the heater from the air bearing surface means the distance of a portion nearest to the air bearing surface, in the heater depicted in FIG. 4.

As depicted in the graph of FIG. 6, as the distance of the heater from the air bearing surface becomes smaller, i.e. as the heater is disposed nearer to the front as viewed from the air bearing surface, the protrusion amount of the magnetic head at the air bearing surface becomes larger. Also, as depicted in the graph of FIG. 7, as the distance of the heater from the air bearing surface becomes smaller, the time constant becomes smaller, and it will be understood that the reaction of the deformation to the energization is quicker.

The heater 33 in the magnetic head 3 of the present embodiment does not have a meandering shape but has a simple shape, so that the heater 33 is disposed at a position such that the distance from the air bearing surface S overlaps with the main magnetic pole 311, more particularly at a position nearer to the air bearing surface S than the connection section 314.

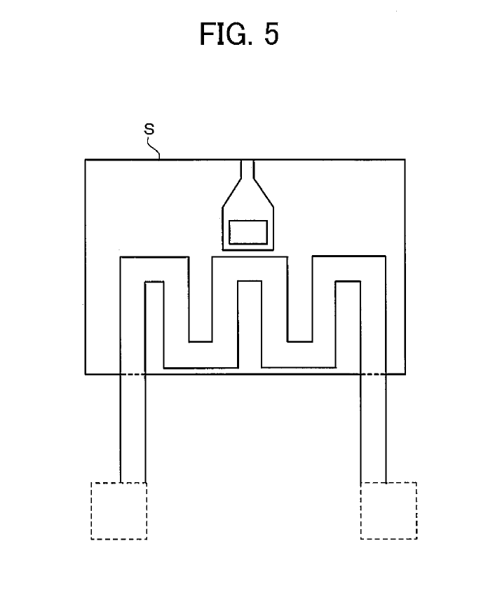

FIG. 5 is a view illustrating a magnetic head as a comparative example having a heater with a meandering shape.

In the magnetic head of the comparative example depicted in FIG. 5, the heater that adjusts the floating-up amount of the magnetic head has a meandering shape, so that the heater cannot be disposed at a position where the distance from the air bearing surface S overlaps with the main magnetic pole 311.

In contrast, the heater 33 of the present embodiment does not have a meandering shape but has a simple shape, so that the heater 33 is disposed at a position where the distance from the air bearing surface S overlaps with the main magnetic pole 311, more particularly at a position nearer to the air bearing surface S than the connection section 314. Therefore, with the same amount of electric current, the amount of deformation of the air bearing surface increases. Also, the heater of the present embodiment can be formed with a conductor layer of one single layer, so that the production is facilitated as compared with the case in which the path of electric current is provided over multiple layers.

In the magnetic head 3 of the present embodiment, the electric current of the heater 33 intersects the magnetic flux that is generated by the thin film coils 316A, 316B for recording. For this reason, there are concerns about the leakage magnetic flux that is generated by the energization of the heater, in addition to the magnetic flux that is generated by the thin film coils 316A, 316B.

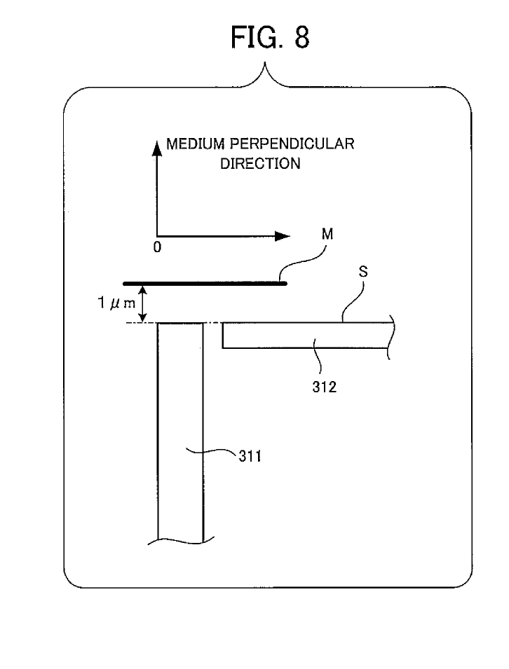

As to the leakage magnetic flux that is generated by the energization of the heater, research has been made by a magnetic field analysis using the finite element method. Using the magnetic head of the present embodiment as a model, the magnetic flux density in the medium perpendicular direction has been determined at the measurement position M located away from the air bearing surface S by 1 μm under an arrangement condition of the main magnetic pole 311 and the auxiliary magnetic pole 312 depicted in FIG. 8.

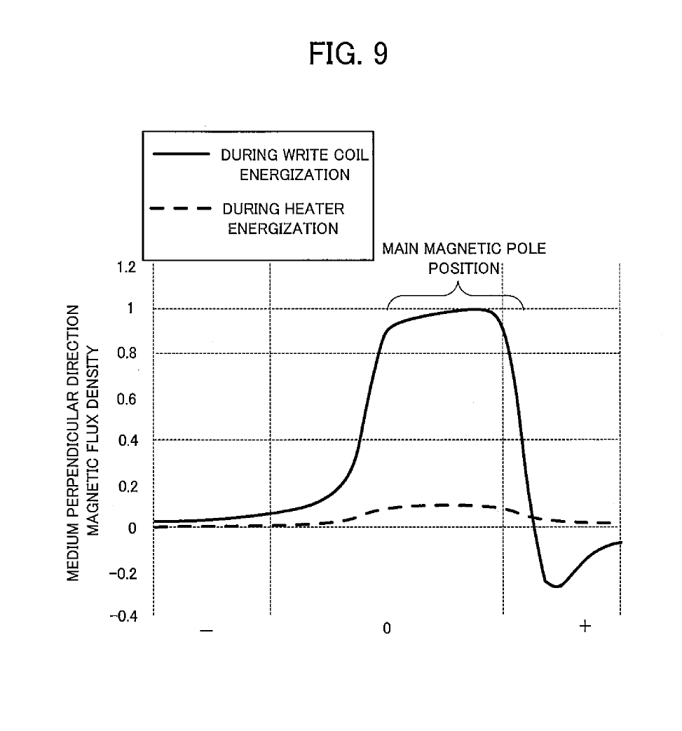

FIG. 9 is a graph illustrating the distribution of the medium perpendicular direction magnetic flux density. The lateral axis of the graph represents the position along the air bearing surface S, where the air flow-out side is “+”, and the air flow-in side is “−”. The symbol “0” represents the position at the end of the main magnetic pole 311 on the air flow-in side. Also, the solid line of the graph represents the magnetic flux density that is generated by the thin film coils 316A, 316B for recording, and the broken line represents the magnetic flux density that is generated by heater energization with the same electric current as in the thin film coils. Here, the magnetic flux density is depicted by being normalized with the obtained maximum magnetic flux density being regarded as 1.

As depicted in the graph of FIG. 9, in both cases of thin film coil energization and heater energization, a large magnetic flux density distribution is obtained in the neighborhood of the main magnetic pole. Here, however, the magnetic flux (broken line) generated at the time of heater energization is less than or equal to 1/10 of the magnetic flux (solid n line) generated at the time of thin film coil energization, more particularly it is 0.093, which is very small. Also, assuming that the resistance of the heater is about 100Ω, the heater generates heat to a degree sufficient for deformation with a smaller electric current than the writing electric current with which the thin film coils are energized. Therefore, the leakage magnetic flux at the time of heater energization will be further smaller in actual cases, whereby it will be understood that the influence of the leakage magnetic flux given to the recording by the heater energization is small.

Next, a concrete second embodiment of the magnetic head will be described. In the following description of the second embodiment, the same element as each element in the embodiments described so far will be denoted with the same symbol, and the difference from the above-described embodiments will be described.

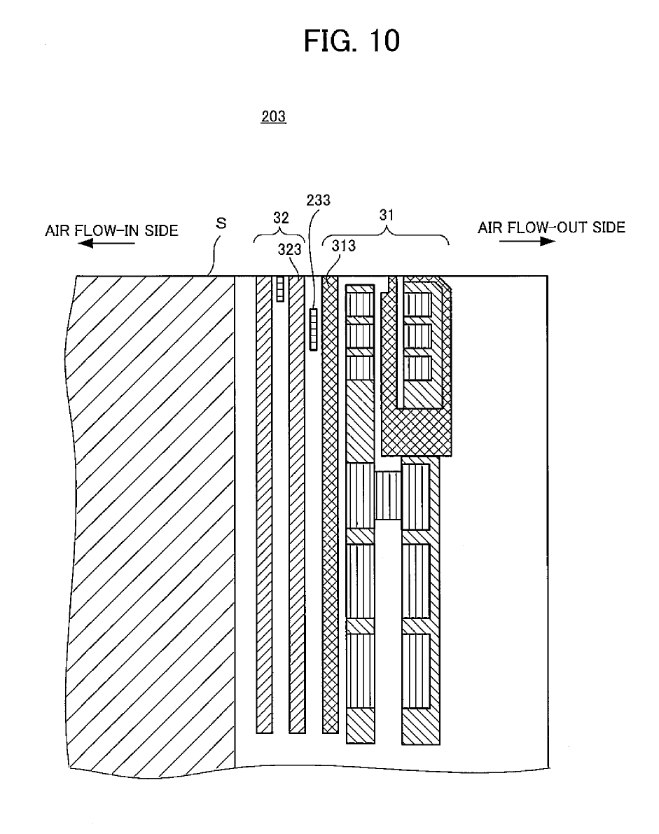

FIG. 10 is an enlarged cross-sectional view illustrating a structure of an element forming section of the magnetic head in the second embodiment.

A magnetic head 203 depicted in FIG. 10 is different from the magnetic head 3 of the first embodiment depicted in FIG. 3 in that a heater 233 for adjusting the floating-up amount from the storage medium is disposed outside the recording element 31. Specifically, the heater 233 is disposed between the recording element 31 and the reproduction element 32, and more specifically, the heater 233 is disposed between the auxiliary magnetic pole 313 that is disposed on the reproduction element 32 side, of the two auxiliary magnetic poles 312, 313 included in the recording element 31, and the magnetic shield layer 323 that is disposed on the recording element 31 side, of the two magnetic shield layers 322, 323 included in the reproduction element 32. Here, the shape depicted in FIG. 4 is applicable to that of the heater 233 as it is.

In the magnetic head 203 of the second embodiment, the heater 33 is disposed outside the recording element 31, so that the electric current that flows through the heater 33 does not intersect the magnetic flux generated by the thin film coils 316A, 316B for recording. Therefore, the influence given by the leakage magnetic flux due to the electric current that flows through the heater 33 is further restrained.

So far, an example has been described in which the heater is formed of one layer; however, the heater may extend to bifurcate into two. Next, a concrete third embodiment of the magnetic head will be described. In the following description of the third embodiment, the same element as each element in the embodiments described so far will be denoted with the same symbol, and the difference from the above-described embodiments will be described.

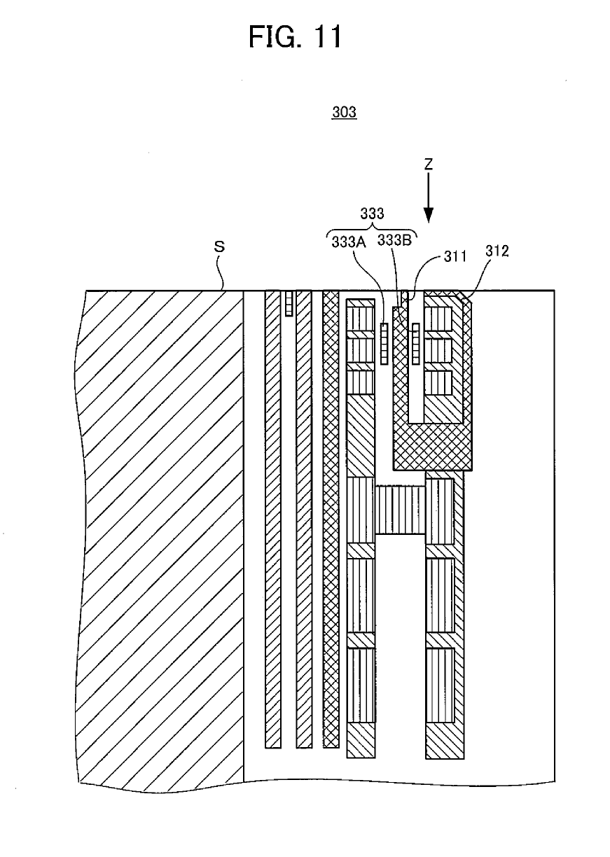

FIG. 11 is an enlarged cross-sectional view illustrating a structure of an element forming section of the magnetic head in the third embodiment.

A magnetic head 303 depicted in FIG. 11 is different from the magnetic head 3 of the first embodiment depicted in FIG. 3 in that a heater 333 for adjusting the floating-up amount from the storage medium extends to bifurcate into two so as to interpose the main magnetic pole 311 therebetween.

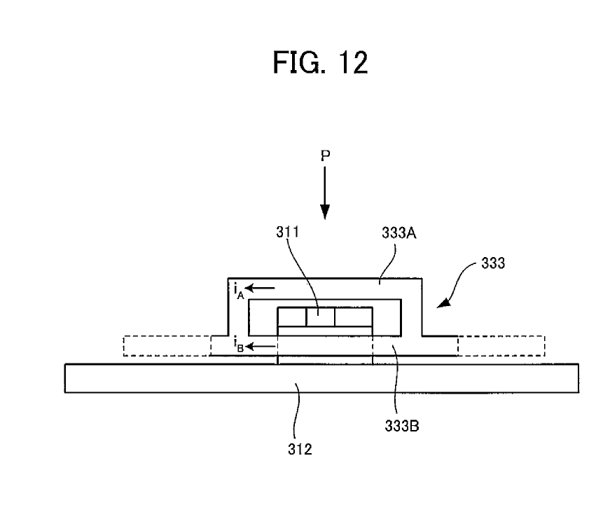

FIG. 12 is a view for describing the structure of the heater depicted in FIG. 11. FIG. 12 depicts a perspective view of the main magnetic pole 311, the auxiliary magnetic pole 312, and the heater 333 of the magnetic head 303 as viewed in the Z-direction in FIG. 11, namely, a perspective view as viewed from the side of the magnetic disk.

As depicted in FIG. 12, the heater 333 bifurcates into two at the neighboring region of the proximate point p to the main magnetic pole 311. The branch paths 333A and 333B of the heater that has bifurcated into two are disposed at positions that interpose the main magnetic pole 311 therebetween.

According to the magnetic head 303 of the third embodiment, the electric current that flows through the heater 333 is branched into the branch path 333A and the branch path 333B at the neighboring region of the proximate point p to the main magnetic pole 311, and flows approximately in the same direction while interposing the main magnetic pole 311 therebetween, and joins together thereafter. As a result of this, the magnetic flux that is generated in the main magnetic pole 311 by the electric current that flows through the one branch path 333A and the magnetic flux that is generated in the main magnetic pole 311 by the electric current that flows through the other branch path 333B cancel to each other, so that the influence by the leakage magnetic flux due to the electric current that flows through the heater 333 is further restrained.

Next, a concrete fourth embodiment of the magnetic head will be described. In the following description of the fourth embodiment, the same element as each element in the embodiments described so far will be denoted with the same symbol, and the difference from the above-described embodiments will be described.

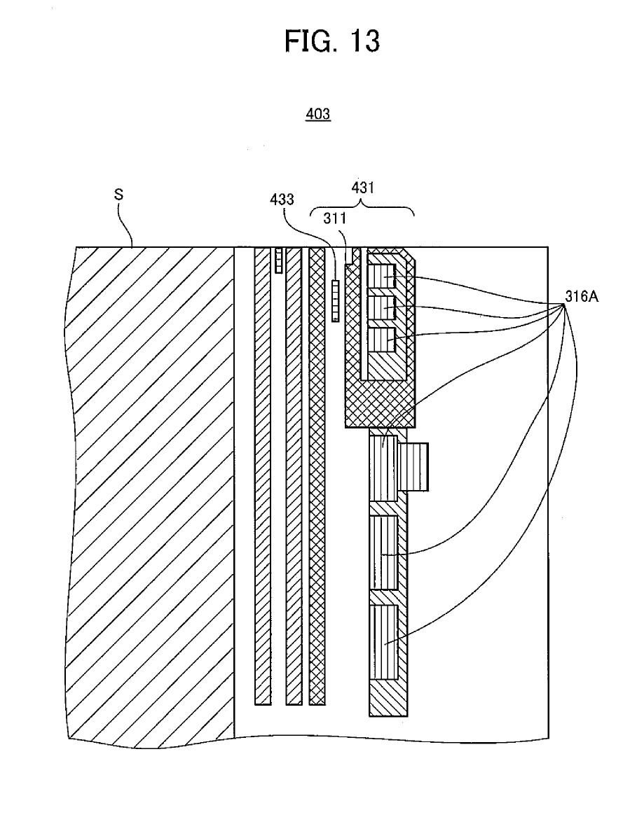

FIG. 13 is an enlarged cross-sectional view illustrating a structure of an element forming section of the magnetic head in the fourth embodiment.

A magnetic head 403 depicted in FIG. 13 is different from the magnetic head 3 of the first embodiment depicted in FIG. 3 in that a single coil system is used in a recording element 431 and that only one thin film coil 316A for recording is provided.

Even with a recording element 431 of a single coil system, a heater 433 is disposed at a position where the distance from the air bearing surface S overlaps with the main magnetic pole 311, so that the deformation amount of the air bearing surface increases.

Next, a concrete fifth embodiment of the magnetic head will be described. In the following description of the fifth embodiment, the same element as each element in the embodiments described so far will be denoted with the same symbol, and the difference from the above-described embodiments will be described.

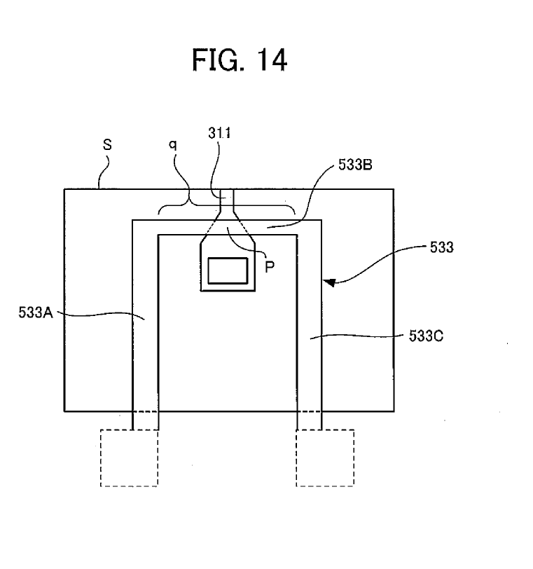

FIG. 14 is a view illustrating a structure of the heater of the magnetic head in the fifth embodiment. FIG. 14 illustrates a shape of a heater 533 as viewed in the moving direction R′ of the magnetic head (See FIG. 2).

In the heater 533 depicted in FIG. 14, a parallel section 533B disposed in a neighboring region q of the proximate point p to the main magnetic pole 311 is formed to be narrower than approach sections 533A, 533C disposed in the regions on both sides of the neighboring region q. For this reason, when electric current flows, the portion near to the air bearing surface S of the magnetic head can be heated to a higher temperature than the other portions. Therefore, as compared with the first embodiment, the air bearing surface S can be greatly deformed while maintaining the electric current to be equal.

Next, a concrete sixth embodiment of the magnetic head will be described. In the following description of the sixth embodiment, the same element as each element in the embodiments described so far will be denoted with the same symbol, and the difference from the above-described embodiments will be described.

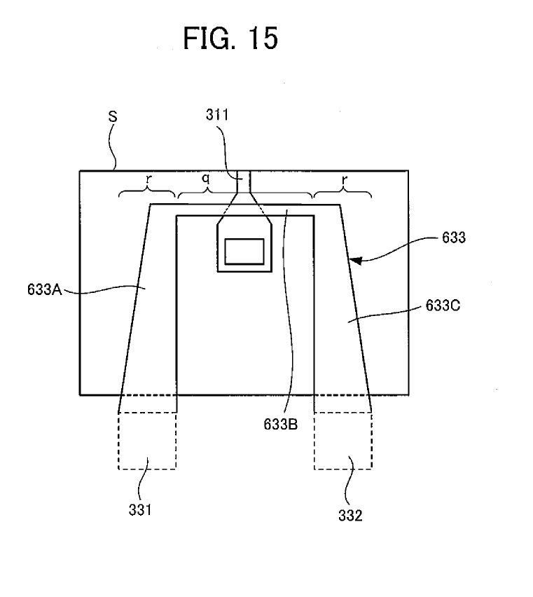

FIG. 15 is a view illustrating a structure of the heater of the magnetic head in the sixth embodiment. FIG. 15 illustrates a shape of a heater 633 as viewed in the moving direction R′ of the magnetic head (See FIG. 2).

In the heater 633 depicted in FIG. 15, a parallel section 633B disposed in the neighboring region q of the proximate point p to the main magnetic pole 311 is formed to have a smaller width than those of approach sections 633A, 633C disposed in regions r on both sides of the neighboring region q, and further, each of the approach sections 633A, 633C of the heater 633 has a tapered shape toward the air bearing surface S, Namely, the approach sections 633A, 633C are formed to have a smaller width as they approach the air bearing surface S from the respective two heater joints 331, 332.

This heater 633 has a smaller width and a higher electric resistance at a portion nearer to the air bearing surface S. Therefore, when electric current flows, the portion near to the air bearing surface S of the magnetic head can be heated to a higher temperature than the other portions.

In the above-described embodiments, description has been made on a case in which the heater has a linearly extending shape. Next, a concrete seventh embodiment of the magnetic head in which the heater has a curvilinear shape will be described. In the following description of the seventh embodiment, the same element as each element in the embodiments described so far will be denoted with the same symbol, and the difference from the above-described embodiments will be described.

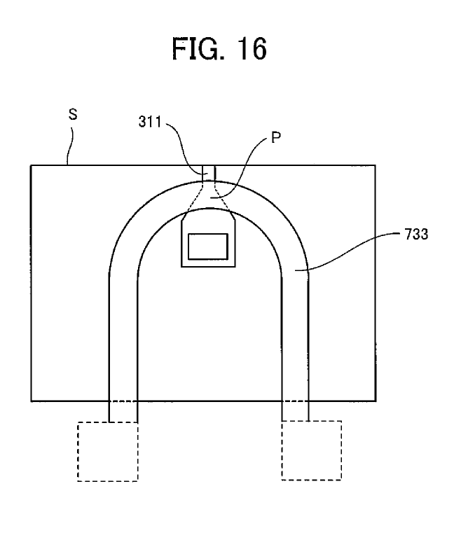

FIG. 16 is a view illustrating a structure of the heater of the magnetic head in the seventh embodiment. FIG. 16 illustrates a shape of a heater 733 as viewed in the moving direction R′ of the magnetic head (See FIG. 2).

In the same manner as the heater of other embodiments described so far, the heater 733 depicted in FIG. 16 has a shape of extending towards the air bearing surface S up to a proximate distance d at which the distance from the air bearing surface S overlaps with the main magnetic pole 311 while monotonously decreasing the distance from the air bearing surface S, passing the proximate point p to the main magnetic pole 311, and extending away from the air bearing surface S while monotonously increasing the distance from the air bearing surface S after passing the proximate point p. However, the heater 733 depicted in FIG. 16 is different from the heater of other embodiments in that the heater 733 has a construction of generally curvilinear shape. In more detail, the heater 733 generally has a U-letter shape.

Next, a concrete eighth embodiment of the magnetic head will be described in which the proximate point neighboring region of the main magnetic pole is formed to have a smaller width than those of the regions on both sides of the neighboring region in the heater having a curvilinear shape. In the following description of the eighth embodiment, the same element as each element in the embodiments described so far will be denoted with the same symbol, and the difference from the above-described embodiments will be described.

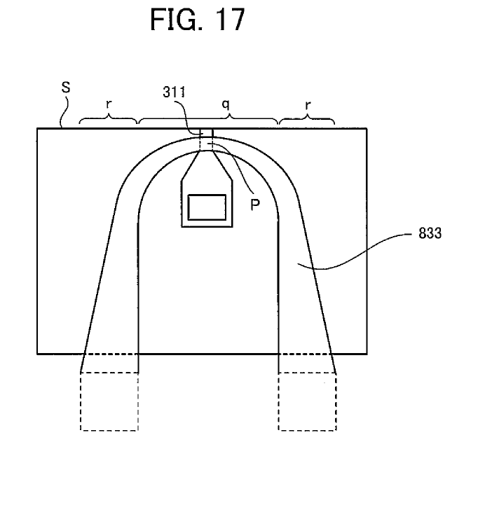

FIG. 17 is a view illustrating a structure of the heater of the magnetic head in the eighth embodiment. FIG. 17 illustrates a shape of a heater 833 as viewed in the moving direction R′ of the magnetic head (See FIG. 2).

The heater 833 generally has a U-letter shape, and has a shape of extending towards the air bearing surface S up to a proximate distance d at which the distance from the air bearing surface S overlaps with the main magnetic pole 311 while monotonously decreasing the distance from the air bearing surface S, passing the proximate point p to the main magnetic pole 311, and extending away from the air bearing surface S while monotonously increasing the distance from the air bearing surface S after passing the proximate point p.

Next, a concrete ninth embodiment of the magnetic head in which the thickness of the heater is different will be described. In the following description of the ninth embodiment, the same element as each element in the embodiments described so far will be denoted with the same symbol, and the difference from the above-described embodiments will be described.

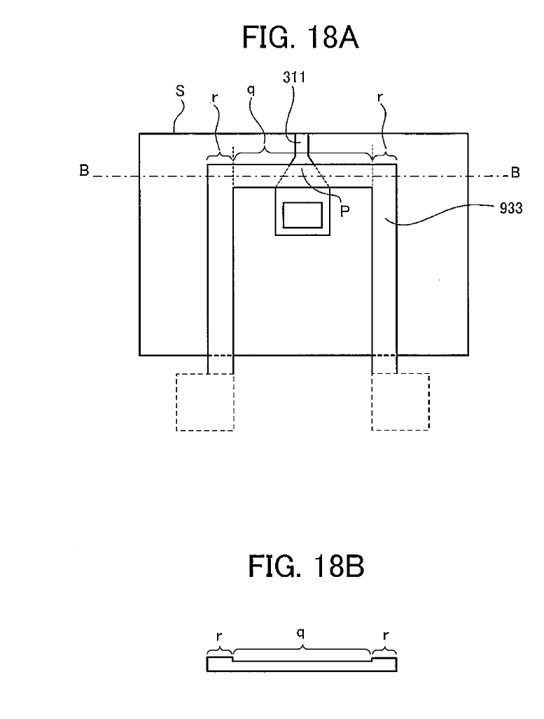

FIG. 18 is a view illustrating a structure of the heater of the magnetic head in the ninth embodiment. FIG. 18A illustrates a shape of a heater 933 as viewed in the moving direction R′ of the magnetic head (See FIG. 2). FIG. 18B is a cross-sectional view of the heater 933 along the B-B line in FIG. 18A.

As depicted more clearly in FIG. 18B, in the heater 933 depicted in FIG. 18A, the thickness of the layer in the neighboring region q of the proximate point p to the main magnetic pole 311 is formed to be smaller than the thickness of the layer in the regions r on both sides of the neighboring region q. For this reason, when electric current flows, the portion near to the air bearing surface S of the magnetic head can be heated to a higher temperature than the other portions. Therefore, as compared with the first embodiment, the air bearing surface S can be greatly deformed while maintaining the electric current to be equal.

Next, a concrete tenth embodiment of the magnetic head having a different resistivity of the heater will be described. In the following description of the tenth embodiment, description will be made by commonly using FIG. 18A in the ninth embodiment.

The heater of the magnetic head in the tenth embodiment has approximately equal width and thickness anywhere; however, the resistivity of the material in the neighboring region q of the proximate point p to the main magnetic pole 311 is higher than the resistivity of the material in the regions r on both sides of the neighboring region q. The resistivity is adjusted by changing the ratio of nickel and copper when the heater is formed of a nickel copper alloy, for example.

In the magnetic head in the tenth embodiment, when electric current flows, the portion near to the air bearing surface S of the magnetic head can be heated to a higher temperature than the other portions. Therefore, as compared with the first embodiment, the air bearing surface S can be greatly deformed while maintaining the electric current to be equal.

Several examples have been described regarding the shape of the heater; however, for the heater, various shapes can be used in correspondence with the position of the heater joint as a connection terminal.

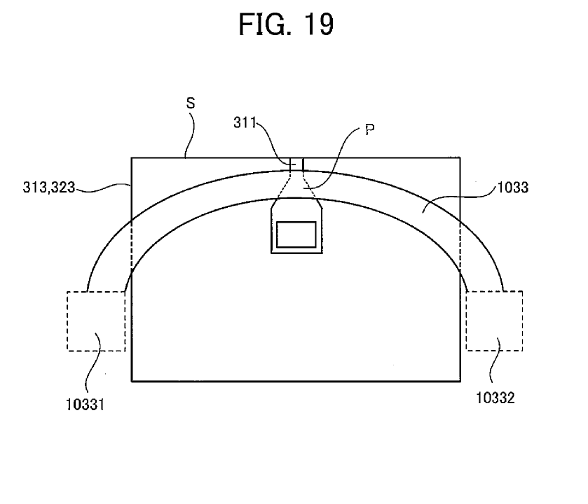

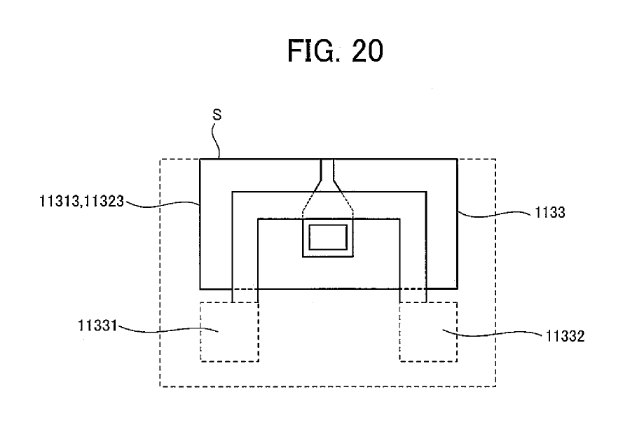

FIGS. 19 and 20 are views illustrating modification examples in which the position of the heater joint is different.

In the magnetic head depicted in FIG. 19, two heater joints 10331, 10332 are disposed at positions where the auxiliary magnetic pole 313 and the magnetic shield layer 323 are avoided in a direction the air bearing surface S extends to. Also, a heater 1033 has a shape that extends between these two heater joints 10331, 10332.

In the magnetic head depicted in FIG. 20, two heater joints 11331, 11332 are disposed on the opposite side of the air bearing surface S from an auxiliary magnetic pole 11313 a magnetic shield layer 11323. Also, a heater 1133 has a shape that extends between these two heater joints 11331, 11332. In the magnetic head depicted in FIG. 20, the auxiliary magnetic pole 11313 and the magnetic shield layer 11323 are smaller as compared with the magnetic head of the above-described other embodiments. However, the heater 1133 of the present embodiment has a shape of extending towards the air bearing surface S up to a proximate distance while monotonously decreasing the distance from the air bearing surface S, and extending away from the air bearing surface S while monotonously increasing the distance from the air bearing surface S after passing the proximate point p. For this reason, when the auxiliary magnetic pole 11313 and the magnetic shield layer 11323 are reduced in scale, the auxiliary magnetic pole 11313 and the magnetic shield layer 11323 can be disposed at the proximate distance that overlaps with the main magnetic pole 311.

Here, in the above description on each of the concrete embodiments, the construction of a magnetic head of vertical recording type has been given as an example of the magnetic head in the basic embodiments described in the “Summary”. However, the magnetic head may be a magnetic head of in-plane recording type instead of the magnetic head of vertical recording type.

According to the basic embodiments of the magnetic head and the magnetic storage device disclosed in the present invention, the heater is disposed at a position close to the air bearing surface in a simple shape of the heater that does not meander. Therefore, with a simple construction easy for manufacturing, it is possible to increase the amount of deformation on the air bearing surface while restraining the increase in the electric current.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic head that floats up while directing an air bearing surface to a relatively moving storage medium and stores information into the storage medium, comprising:
a main magnetic pole that generates a magnetic field for recording information into the storage medium; and
a heater that adjusts a floating-up amount of the magnetic head from the storage medium by deforming the air bearing surface with heat,
wherein the heater has a shape that extends towards the air bearing surface up to a proximate distance at which a distance from the air bearing surface overlaps with the main magnetic pole while monotonously decreasing the distance from the air bearing surface to pass a proximate point to the main magnetic pole, and that extends away from the air bearing surface while monotonously increasing the distance from the air bearing surface after passing the proximate point.

2. The magnetic head according to claim 1, wherein in the heater, a neighborhood region of the proximate point of the heater is formed to become narrower than regions on both sides of the neighborhood region.

3. The magnetic head according to claim 1, wherein in the heater, a region of the proximate point of the heater is formed to become thinner than regions on both sides of the neighborhood region.

4. The magnetic head according to claim 1, wherein in the heater, a region of the proximate point of the heater is formed of a material having a relatively higher resistivity than a material of regions on both sides of the neighborhood region.

5. The magnetic head according to claim 1, wherein the heater extends to bifurcate into two so as to interpose the main magnetic pole therebetween at a neighborhood region of the proximate point.

6. A magnetic storage device comprising:
a storage medium into which information is magnetically recorded;
a magnetic head that floats up while directing an air bearing surface to the relatively moving storage medium and records information into the storage medium; and
an electronic circuit that supplies an electric signal to the magnetic head,
wherein the magnetic head comprises:
a main magnetic pole that gives magnetism for recording information into the storage medium; and
a heater that adjusts a floating up amount of the magnetic head from the storage medium by deforming the air bearing surface with heat,
wherein the heater has a shape that extends towards the air bearing surface up to a proximate distance at which a distance from the air bearing surface overlaps with the main magnetic pole while monotonously decreasing the distance from the air bearing surface to pass a proximate point to the main magnetic pole, and that extends away from the air bearing surface while monotonously increasing the distance from the air bearing surface after passing the proximate point.

7. The magnetic storage device according to claim 6, wherein in the heater, a neighborhood region of the proximate point of the heater is formed to become narrower than regions on both sides of the neighborhood region.

8. The magnetic storage device according to claim 6, wherein in the heater, a region of the proximate point of the heater is formed to become thinner than regions on both sides of the neighborhood region.

9. The magnetic storage device according to claim 6, wherein in the heater, a region of the proximate point of the heater is formed of a material having a relatively higher resistivity than a material of regions on both sides of the neighborhood region.

10. The magnetic storage device according to claim 6, wherein the heater extends to bifurcate into two so as to interpose the main magnetic pole therebetween at a neighborhood region of the proximate point.
